(19) United States
(12) Patent Application Publication
(10) Pub. No.: US 2014/0347601 A1
(43) Pub. Date: Nov. 27, 2014

(54) LUMINESCENT LAYER WITH UP-CONVERTING LUMINOPHORES

(71) Applicants: Gary Gibson, Palo Alto, CA (US); Xia Sheng, Palo Alto, CA (US); Richard H. Henze, San Carlos, CA (US)

(72) Inventors: Gary Gibson, Palo Alto, CA (US); Xia Sheng, Palo Alto, CA (US); Richard H. Henze, San Carlos, CA (US)

(21) Appl. No.: 14/345,311

(22) PCT Filed: Oct. 28, 2011
(86) PCT No.: PCT/US2011/058428

§ 371 Date: Mar. 17, 2014

(51) Int. Cl. G02F 1/1335; C09K 11/02; G02B 26/00; G02F 1/167; G02B 5/08; G02B 26/02

(52) U.S. Cl. CPC G02F 1/133617; G02B 5/08; G02B 26/02; G02B 26/005; G02F 1/167; G02F 1/133609; C09K 11/025; G02F 2001/133614; G02F 2001/133618; C09K 2211/182; C09K 2211/181; C09K 2211/14
USPC 349/62; 359/884; 359/227; 359/228; 428/690; 252/301.36

(57) ABSTRACT

A luminescent layer includes a series of down-converting luminophores dispersed in a matrix to collect ambient light energy over a range of wavelengths longer than a desired color band and a set of up-converting luminophores dispersed in the matrix. The series of down-converting luminophores transfer the ambient light energy to the set of up-converting luminophores, and the set of up-converting luminophores emits at least a portion of the ambient light energy in the desired color band.

### BACKGROUND

A reflective display is a device in which ambient light is used for viewing the displayed information by reflecting desired portions of the incident ambient light spectrum back to a viewer. Because these displays rely on ambient light, the displays often have a difficult time effectively displaying a full color gamut with sufficient brightness. As a result, reflective displays are generally not able to provide adequate performance for the display of full color images.

### BRIEF DESCRIPTION OF THE DRAWINGS

FIG. 1 is a schematic diagram illustrating one embodiment of a luminescent layer with a series of down-converting luminophores and up-converting luminophores.

FIG. 2 is a graphical diagram illustrating one embodiment of absorption and emission bands of a series of down-converting luminophores and up-converting luminophores with respect to a desired color band.

FIGS. 3A-3B are block diagrams illustrating embodiments of a luminescent layer with two series of down-converting luminophores and up-converting luminophores.

FIG. 4 is a graphical diagram illustrating one embodiment of absorption and emission bands of two series of down-converting luminophores and up-converting luminophores with respect to a desired color band.

FIGS. 5A-5B are block diagrams illustrating embodiments of a sub-pixel with a luminescent layer.

FIG. 6 is a block diagram illustrating an embodiment of a pixel including a luminescent layer.

FIG. 7 is a schematic diagram illustrating an embodiment of a display device with pixels that include a luminescent layer.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a luminescent layer includes a series of down-converting luminophores and up-converting luminophores. The term luminophore as used herein refers to an atom or atomic grouping in a chemical compound that manifests photoluminescence. The terms “down-converting” or “down-conversion” as used herein refer to the process of absorbing photons with relatively high energy and then re-emitting some fraction of their absorbed energy in the form of photons with lower energy than the absorbed photons. The terms “up-converting” or “up-conversion” as used herein refer to processes that involve absorption of low energy photons and conversion of some fraction of their energy to higher energy photons. The down-converting luminophores collect ambient light energy over a broad range of wavelengths that are generally longer than a desired color band and transfer the energy to the up-converting luminophores via processes such as Förster exchange, direct emission and absorption of photons, and Dexter Exchange. The up-converting luminophores absorb the transferred energy and emit a portion of the energy in a desired color spectrum. By doing so, the up-converting luminophores increase the lightness of the desired color spectrum to result in enhanced color performance for reflective displays.

FIG. 1 is a schematic diagram illustrating one embodiment 100A of a luminescent layer 100 with a series of down-converting luminophores 120 and a set of one or more types of up-converting luminophores 130 (referred to hereafter as up-converting luminophores 130) dispersed in a matrix 140. Luminescent layer 100A receives ambient light 110 that is incident on layer 100A and emits light in a desired color band 112 (e.g., red, blue, or green) based on a selected composition of down-converting luminophores 120 and up-converting luminophores 130 in matrix 140. The series of down-converting luminophores 120 absorbs light over a broad range of wavelengths that are generally longer than the desired color band 112 and transfers the energy of the absorbed light to up-converting luminophores 130. Up-converting luminophores 130, in turn, absorb the energy from luminophores 120 and, depending on the efficiency of luminophores 130, emit a portion of the energy in the desired color band 112.

The series of down-converting luminophores 120 include any suitable type, number, and/or combination of luminophores with absorption bands 122 having wavelengths that are generally longer the desired color band 112 and generally shorter than an absorption band 132 of up-converting luminophores 130. The lowest energy down-converting collection luminophore 120 in the series has an emission band 124 that at least partially overlaps with an absorption band 132 of up-converting luminophores 130 to allow the transfer of energy between the series of luminophores 120 and up-converting luminophores 130 to occur through processes such as Förster Exchange, direct emission and absorption of photons, and Dexter Exchange. Luminophores 120 may include, but are not limited to, organic and inorganic dyes and luminophores, semiconducting nanoparticles, photoluminescent oligomers or polymers, and pigment particles containing photoluminescent dye molecules, oligomers, or polymers.

Up-converting luminophores 130 include any suitable type, number, and/or combination of luminophores, including phosphors, that up-convert longer wavelengths of light to shorter wavelengths of light. In particular, luminophores 130 are selected to have an absorption band 132 that at least partially overlaps with the emission band 124 of the lowest energy collection down-converting luminophore 120 in the series and an emission band 134 that at least partially overlaps with the desired color band 112. Up-converting luminophores 130 may include, but are not restricted to, inorganic and organic phosphors, semiconducting nanocrystals, and organic molecules, oligomers, or polymers

Matrix 140 may be any suitable solid film, composite, or liquid dispersion material for dispersing down-converting luminophores 120 and up-converting luminophores 130. If down-converting luminophores 120 and up-converting luminophores 130 are embedded in matrix 140, the material of matrix 140 may be selected to be substantially transparent at wavelengths that are to be absorbed or emitted by down-converting luminophores 120 and up-converting luminophores 130.

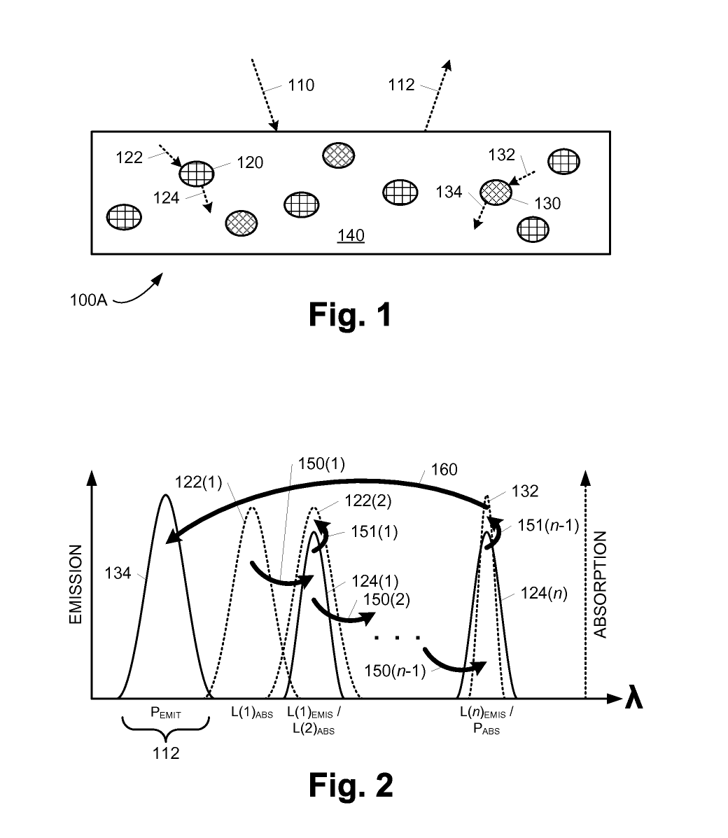

FIG. 2 is a graphical diagram illustrating one embodiment of absorption and emission bands of the series of down-converting luminophores 120 and up-converting luminophores 130 with respect to desired color band 112. FIG. 2 shows the relationship between absorption bands 122 and emission bands 124 of the luminophores 120 in the series as a function of wavelength as well as the relationship between the emission band 124 of the lowest energy collection luminophore 120 in the series and absorption band 132 and emission band 134 of up-converting luminophores 130. As shown in FIG. 2, the series of down-converting luminophores 120 includes luminophores 120(1)-120(n) (shown as L(1)-L(n), respectively, in FIG. 2), where n is an integer that is greater than or equal to one. Down-converting luminophores 120(1)-120(n) serially transfer at least some of the absorbed energy to up-converting luminophores 130. A highest energy collection luminophore 120(1) has an absorption band 122(1) with wavelengths that are generally longer the desired color band 112 and an emission band 124(1) that at least partially overlaps with an absorption band 122(2) of the next luminophore 120(2) in the series. Luminophore 120(1) absorbs energy from ambient photons in absorption band 122(1) and emits at least some of the absorbed energy in emission band 124(1) as indicated by an arrow 150(1). Luminophore 120(2) then absorbs at least some of the emitted energy from luminophore 120(1), as indicated by an arrow 151(1), along with some ambient photons in absorption band 122(2) and emits at least some of the absorbed energy in emission band 124(2) as indicated by an arrow 150(2). The remaining luminophores 120 in the series operate similarly to serially transfer energy to the next highest energy collection luminophore 120 until the lowest energy collection luminophore 120(n) is reached as indicated by arrow 150(n-1).

Because the emission band 122(n) of the lowest energy collection luminophore 120(n) at least partially overlaps with the absorption band 134 of up-converting luminophores 130, luminophores 130 absorb at least some of the energy from the lowest energy collection luminophore 120(n), as indicated by an arrow 151(n), along with some ambient photons in absorption band 132. Up-converting luminophores 130, depending on their efficiency, transfer a portion of this energy to emission band 134 where the energy is emitted in the desired color band 112 as indicated by an arrow 160. In particular, energy from the lowest energy luminophore 120(n) excites the up-conversion luminophores 130 in two or more sequential steps. A first energy transfer from down-converting luminophore 120(n), or an ambient photon absorbed directly by up-converting luminophore 130, takes an up-converting luminophore 130 to a higher energy state. A second energy transfer from down-converting luminophore 120(n) or absorption of a second ambient photon by up-converting luminophore 130 causes up-converting luminophore 130 to be excited to a higher energy state and emit a photon with a wavelength that is in a range of shorter wavelengths that at least partially overlap the desired color band 112. Emission of this photon returns up-converting luminophore 130 to a lower energy state.

The energy transfer between luminophores 120 and between luminophores 120 and luminophores 130 can occur through processes such as Förster Exchange, direction radiation and re-absorption, and Dexter Exchange. Förster exchange, as described by T. Förster, Ann. Phys. 6, 55 (1948), involves the transfer of energy from an excited donor state in one particle or system to an acceptor state in another particle or system via an electromagnetic dipole-dipole interaction. The rate for Förster exchange generally depends on the donor-acceptor spectral overlap, the relative orientation of the donor and acceptor transition dipole moments, and the distance between donor and acceptor. The rate for Förster exchange generally falls as 1/R⁶, where R is the distance between donor and acceptor, and such exchange can typically occur over distances between a few nanometers and 20 nanometers. Although direct radiation and re-absorption may occur, this process may be less effective than Förster exchange due to the relatively small cross-section for direct absorption.

As an example, luminophores 120 may include a series of down-converting luminescent organic relay dyes, up-converting luminophores 130 may include phosphors such as Y₂O₂S or NaYF₄:X (X=Er, Tm, Ho, Ce), and matrix 140 includes a transparent polymer such as PMMA that disperses luminophores 120 and the phosphors (i.e., up-converting luminophores 130).

Depending on dopant as well as the size, shape, and crystallography of the phosphors, many combinations of absorption bands 132 and emission bands 134 are possible. In one particular example, Y₂O₂S and NaYF₄:X can be configured to sequentially absorb two ˜980 nm wavelength photons, or accept energy transfers approximately equal to two ˜980 nm wavelength photons, and emit a 540 nm wavelength photon. With such phosphors dispersed in matrix 140 with sufficient density and the lowest energy down-converting luminophore 120 chosen to emit near 980 nm, a large fraction of the light collected by luminophores 120 may be transferred to effectively pump up the phosphors (i.e., up-converting luminophores 130). Because the efficiency of the phosphors may be relatively low, a small fraction of the energy transferred to the phosphors will be emitted at 540 nm. The conversion efficiency is ˜0.5% for NaYF₄:X and ˜1% for some oxysulfides. While some other sulfides may provide efficiencies of 6% or more, these sulfides may be susceptible to photo-bleaching.

Assume, in the above example, that the source of ambient light 110 is sunlight, that luminophores 120 absorb the majority of sunlight between 540 and 980 nm and transfer ˜50% of the light energy in this band to the phosphors, and that 1% of the transferred energy is re-emitted near 540 nm. With these assumptions, a reflective display that includes pixels with luminescent layer 100A (e.g., display 700 shown in FIG. 7 and described in additional detail below) may boost the light power by ˜7% in comparison to a reflector that matches the Specification for Newspaper Advertising Production Specification (SNAP) for green light. A greater benefit may be seen for blue light because of the larger band of ambient light 110 that may be collected.

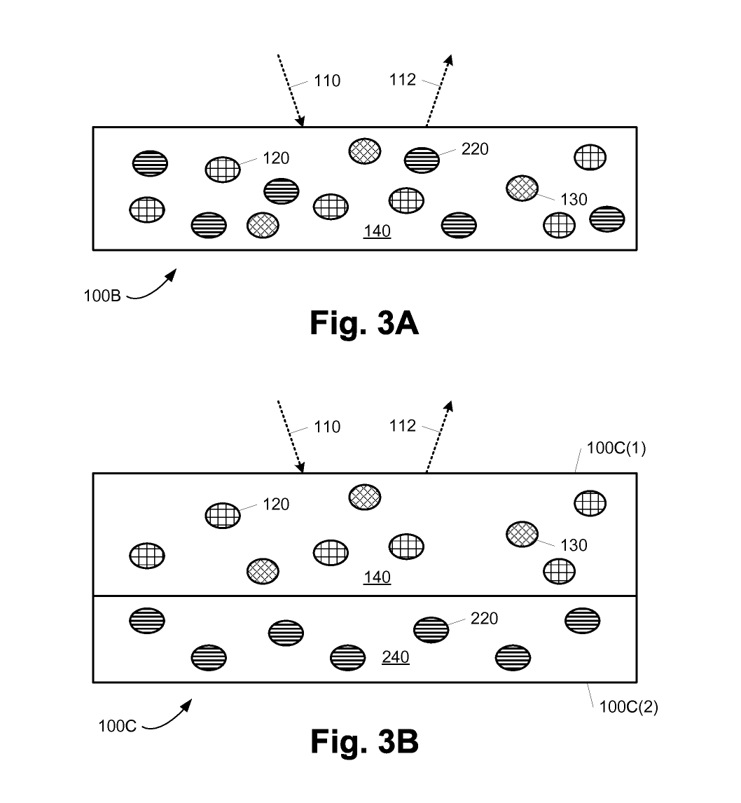

The series of down-converting luminophores 120 and up-converting luminophores 130 described above may also be used in conjunction with a second series of down-converting luminophores 220 configured to collect light from wavelengths generally shorter than the desired color band 112 and emit the light in desired color band 112 without the aid of an up-converting luminophore. FIG. 3A-3B are block diagrams illustrating embodiments 100B and 100C, respectively, of luminescent layer 100 with two series of down-converting luminophores 120 and 220 and up-converting luminophores 130.

In the embodiment of FIG. 3A, luminescent layer 100B receives ambient light 110 that is incident on layer 100B and emits light from desired color band 112 based on a selected composition of down-converting luminophores 120, up-converting luminophores 130, and down-converting luminophores 220 in matrix 140. The series of down-converting luminophores 120 and up-converting luminophores 130 operate as described above. The series of down-converting luminophores 220 absorbs light over a broad range of wavelengths that are generally shorter than the desired color band 112 and emits a portion of the energy to the desired color band 112. As a result, light from both up-converting luminophores 130 and luminophores 220 is emitted in the desired color band 112.

In the embodiment of FIG. 3B, luminescent layer 100C includes a first sub-layer 100C(1) with down-converting luminophores 120 and up-converting luminophores 130 and a second, adjacent sub-layer 100C(2), above or below sub-layer 100C(1), with the series of down-converting luminophores 220 dispersed in a matrix 240. Matrix 240 may be any suitable solid film, composite, or liquid dispersion material for dispersing luminophores 220. If luminophores 220 are embedded in matrix 240, the material of matrix 240 may be selected to be substantially transparent at wavelengths that are to be absorbed or emitted by luminophores 240.

The choice between a same layer and a separate layer design for luminescent layers 100 with luminophores 220 may depend on the absorption and emission bands of the up and down-converting materials used and the desired color band 112. A single layer may be simpler and less expensive to manufacture but may limit the bandwidth of ambient light 110 that can be used due to re-absorption.

In both embodiments 1008 and 100C, the series of down-converting luminophores 220 include any suitable type and/or combination of luminophores with absorption bands 122 having wavelengths that are generally shorter the desired color band 112. The lowest energy collection luminophore 120 in the series has an emission band 124 that at least partially overlaps the desired color band 112. Generally, a luminophore 220 is an atom or atomic grouping in a chemical compound that manifests luminescence. Luminophores 220 may include, but are not limited to, organic and inorganic dyes and luminophores, semiconducting nanoparticles, photoluminescent oligomers or polymers, and pigment particles containing luminescent dye molecules, oligomers, or polymers.

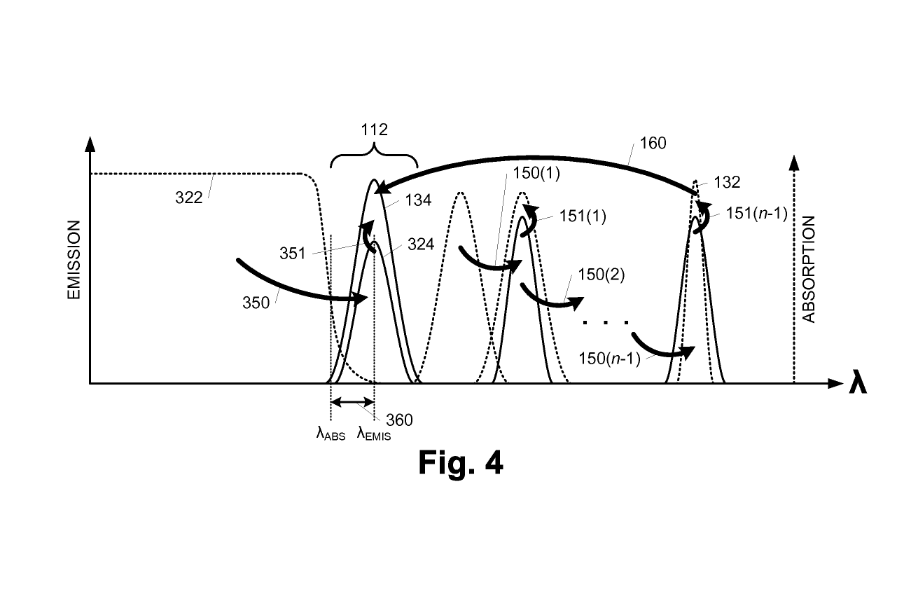

FIG. 4 is a graphical diagram illustrating one embodiment of absorption and emission bands of two series of down-converting luminophores 120 and 220 and up-converting luminophores 130 with respect to the desired color band 112. FIG. 4 illustrates the operation of down-converting luminophores 120 and up-converting luminophores 130 with arrows 150(1)-150(n-1), 151(1)-151(n-1), and 160 as described above with reference to FIG. 2. FIG. 4 shows the relationship between absorption band 322 and emission band 324 of the series of down-converting luminophores 220 as a function of wavelength.

As shown in FIG. 4, the series of down-converting luminophores 220 collectively have an absorption band 322 with wavelengths that are generally shorter than the desired color band 112 as indicated by a wavelength absorption edge λ_{ABS}. Down-converting luminophores 220(1)-220(n) serially transfer at least some of the absorbed energy to an emission band 324 of a lowest energy collection luminophore 220 as indicated by an arrow 350. Emission band 324 occurs around an emission wavelength λ_{EMIS} and at least partially overlaps the desired color band 112. As a result, the lowest energy collection luminophore 220 emits at least a portion of the energy collected and transferred from the series of down-converting luminophores 220 in the desired color band 112 as indicated by an arrow 351. The energy transfer between luminophores 220 can occur through processes such as Förster Exchange, direction radiation and re-absorption, and Dexter Exchange as described above. A sufficient Stokes shift (i.e., λ_{EMIS} -λ_{ABS} as represented by an arrow 360 in FIG. 4) may be selected to minimize re-absorption by luminophores 220.

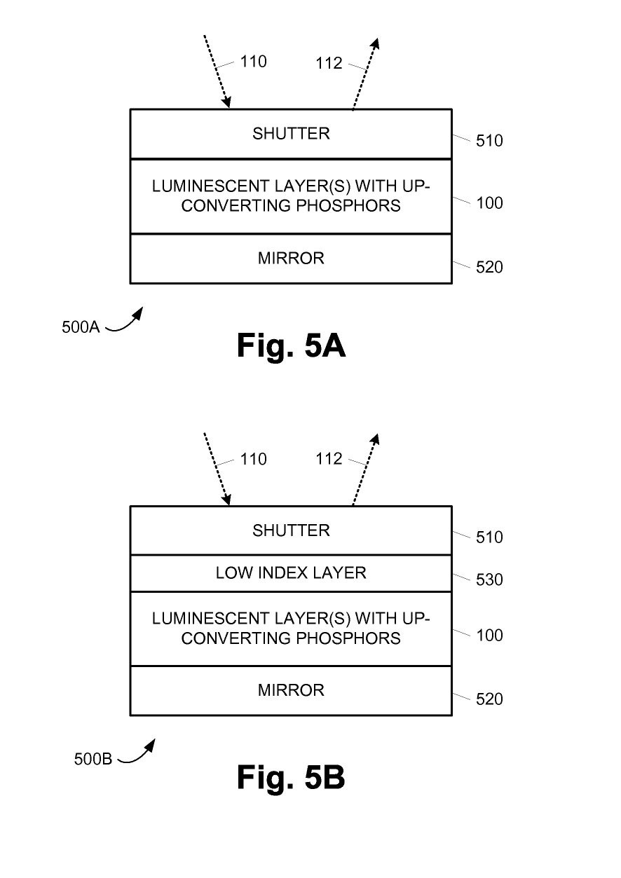

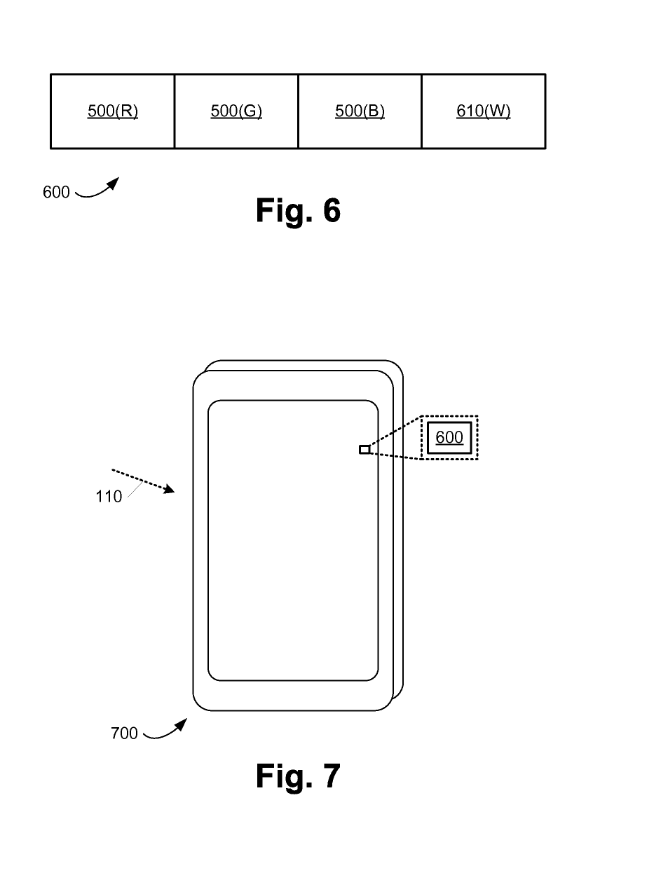

Embodiments 100A, 100B, and 100C of luminescent layer 100 may be used in a variety of pixel and sub-pixel configurations. Embodiments of pixel and sub-pixel configurations will now be described by way of example with reference to FIGS. 5A-5B and 6.

FIG. 5A is a block diagram illustrating an embodiment 500A of a sub-pixel 500 with luminescent layer 100. Sub-pixel 500A includes a shutter 510, luminescent layer 100, and a mirror 520.

Shutter 510 forms the top layer of sub-pixel 500A such that ambient light 110 enters sub-pixel 500A through shutter 510. Shutter 510 is adjustable to control the light transmission that passes through shutter 510. In particular, shutter 510 modulates the intensity of ambient light 110 entering sub-pixel 500A and the intensity of reflected light, including light in the desired color band 112, exiting sub-pixel 500A. Accordingly, shutter 510 controls the amount of light produced by sub-pixel 500A to achieve a desired brightness at any given time.

In some embodiments, shutter 510 may comprise an electro-optical (EO) shutter with a transparency that can be adjusted from mostly transparent to mostly opaque over some range of wavelengths and with some number of intermediate gray levels. The EO shutter may be a black/clear dichroic-liquid crystal (LC) guest-host shutter or an in-plane electrophoretic (EP) shutter, for example. In other embodiments, shutter 510 may comprise a cholesteric liquid crystal shutter or an electrowetting layer shutter.

Luminescent layer 100 is disposed below shutter 510 and absorbs ambient light 110 through shutter 510. Luminescent layer 100 re-emits some of the absorbed ambient light energy in the desired color band 112 as described above and transmits other ambient light 110 to mirror 520. Luminescent layer 100 also receives light reflected from mirror 520 and transmits some of the reflected light through shutter 510.

Mirror 520 is disposed below luminescent layer 100 and is wavelength-selective to reflect only selected bandwidths, such as the desired color band 112 (e.g., red, blue, or green) in some embodiments. In other embodiments the mirror is configured to reflect all ambient optical wavelengths because the absorption length in luminescent layer 100, for some wavelengths desirable for absorption by luminescent layer 100, is greater than the thickness of luminescent layer 100 (i.e., two passes through luminescent layer 100 are needed to absorb the majority of the incident ambient light at these wavelengths). Mirror 520 may be a Bragg stack, an absorbing dye over a broadband mirror, a layer of wavelength-dependent optical scatterers such as plasmonic particles, or other suitable surface or surface configuration designed to reflect at least the desired color band 112. Mirror 520 may also be a diffusive mirror in some embodiments. Mirror 520 reflects light emitted by luminescent layer 100 back toward shutter 510 as well as ambient light 110 not absorbed by luminescent layer 100.

FIG. 5B is a block diagrams illustrating an embodiment 500B of a sub-pixel 500. Sub-pixel 500B further includes a low refractive index layer 530 between shutter 510 and luminescent layer 100. Low refractive index layer 530 minimizes trapping of light in waveguide modes to allow additional light in the desired color band 112 to exit through shutter 510.

FIG. 6 is a block diagram illustrating an embodiment of a pixel 600 with sub-pixels 500(R), 500(G), and 500(B), each including a luminescent layer 100, for modulating red, blue, and green colors, respectively. In particular, sub-pixel 500(R) includes a luminescent layer 100 with a desired color band of red, sub-pixel 500(G) includes a luminescent layer 100 with a desired color band of green, and sub-pixel 500(B) includes a luminescent layer 100 with a desired color band of blue. Pixel 600 also includes an optional white pixel 610(W) for modulating white light. In other embodiments, other color choices and/or numbers of sub-pixels 500 may be used to form a pixel 600. In addition, one or more of sub-pixels 500 may omit luminescent layer 100 or a portion thereof in other embodiments.

FIG. 7 is a schematic diagram illustrating an embodiment of a reflective display device 700 with an array of pixels 600 that include a luminescent layer 100. Display device 700 includes any suitable type of device configured to display images by selectively controlling shutters 510 of pixels 600 using ambient light 110. Display device 700 may represent any suitable type of display device for use as a stand alone display (e.g., a retail sign) or for use as part of a tablet, pad, laptop, or other type of computer, a mobile telephone, an audio/video device, or other suitable electronic device. Display device 700 may include any suitable input devices (not shown), such as a touchscreen, to allow a user to control the operation of device 700. Display device 700 may also include memory (not shown) for storing information to be displayed, one or more processors for processing information to be displayed, and a wired or wireless connection device for accessing additional information to be displayed or processed for display.

In the above embodiments, a back-light or a front-light may be used in conjunction with the ambient light approaches described above for use in viewing under low light conditions.

The luminescent embodiments described herein may advantageously provide greater lightness in reflective displays than non-luminescent approaches by using a much larger fraction of the available ambient spectrum. In particular, the embodiments employ a significant fraction of otherwise wasted longer wavelengths of light to enhance the light output of a pixel. Because of the large amount of energy available at these longer wavelengths in many lighting environments (e.g. sunlight), the up-conversion may provide substantial benefits even considering the inefficiencies of up-conversion processes. The above embodiments provide a method for collecting the longer wavelength energy from a broad spectrum and delivering it to the up-conversion luminophores for re-emission in the desired color band. The method may be also used in combination with other techniques that use shorter wavelengths of light to further boost performance. As a result, color saturation in reflective displays may be enhanced.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A luminescent layer comprising:
a first series of down-converting luminophores dispersed in a first matrix, the first series of down-converting luminophores to collect first ambient light energy over a first range of wavelengths longer than a desired color band; and
a set of up-converting luminophores dispersed in the first matrix;
wherein the first series of down-converting luminophores transfer the first ambient light energy to the set of up-converting luminophores, and wherein the set of up-converting luminophores emits at least a portion of the first ambient light energy in the desired color band.

2. The luminescent layer of claim 1 wherein the first series of down-converting luminophores have a first emission band, and wherein the set of up-converting luminophores have an absorption band that at least partially overlaps the first emission band.

3. The luminescent layer of claim 2 wherein the set of up-converting luminophores have a second emission band that at least partially overlaps the desired color band.

4. The luminescent layer of claim 1 further comprising:
a second series of down-converting luminophores in proximity to the first series of down-converting luminophores, the second series of down-converting luminophores to collect second ambient light energy over a second range of wavelengths shorter than the desired color band and emit at least a portion of the second ambient light energy in the desired color band.

5. The luminescent layer of claim 4 wherein the second series of down-converting luminophores is dispersed in the first matrix.

6. The luminescent layer of claim 4 further comprising:
a first sub-layer including the first matrix; and
a second sub-layer adjacent to the first sub-layer including a second matrix;
wherein the second series of down-converting luminophores is dispersed in the second matrix.

7. A reflective display pixel comprising:
a luminescent layer including a first series of down-converting luminophores and a set of up-converting luminophores, the first series of down-converting luminophores to collect first ambient light energy over a first range of wavelengths longer than a desired color band and to transfer the first ambient light energy to the set of up-converting luminophores, and the set of up-converting luminophores to emit at least a portion of the first ambient light energy in the desired color band; and
a mirror disposed below the luminescent layer.

8. The reflective display pixel of claim 7 wherein the mirror is one of a Bragg stack, an absorbing dye over a broadband mirror, a layer of wavelength-dependent optical scatterers, or a diffuse mirror.

9. The reflective display pixel of claim 7 further comprising:
a shutter with adjustable optical transmission disposed above the luminescent layer.

10. The reflective display pixel of claim 9 further comprising:
a low refractive index layer disposed between the shutter and the luminescent layer.

11. The reflective display pixel of claim 9 wherein the shutter is one of a dichroic guest-liquid crystal host system, an in-plane electrophoretic system, an electro-wetting shutter, or a cholesteric liquid crystal shutter.

12. The reflective display pixel of claim 7 wherein the luminescent layer includes a second series of down-converting luminophores in proximity to the first series of down-converting luminophores, the second series of down-converting luminophores to collect second ambient light energy over a second range of wavelengths shorter than the desired color band and emit at least a portion of the second ambient light energy in the desired color band.

13. A reflective display device comprising:
a plurality of pixels, each pixel including a plurality of color sub-pixels, each color sub-pixel corresponding to a different color, at least one of the color sub-pixels having:
a shutter with adjustable optical transmission disposed above the luminescent layer;
a luminescent layer including a series of down-converting luminophores and a set of up-converting luminophores, the series of down-converting luminophores to collect ambient light energy over a range of wavelengths longer than a desired color band and to transfer the ambient light energy to the set of up-converting luminophores, and the set of up-converting luminophores to emit at least a portion of the ambient light energy in the desired color band; and
a mirror disposed below the luminescent layer.

14. The reflective display device of claim 13 wherein each color sub-pixel corresponds to one of red, green, and blue.

15. The reflective display device of claim 13 where each pixel includes a white sub-pixel.
